(19) United States
(12) Patent Application Publication
(10) Pub. No.: US 2010/0130136 A1
(43) Pub. Date: May 27, 2010

(54) System and Method for Interpreting and Classifying Signals in Communications Systems

(76) Inventors: Hossein Alexander Sepehri-Nik, Coral Gables, FL (US); Fausto Okazaki, Sao Paulo-SP (BR); Marcelo Caneppele, Campinas-SP (BR)

Correspondence Address: GIBSON & DERNIER LLP, 900 ROUTE 9 NORTH, SUITE 504, WOODBRIDGE, NJ, 07095, US

(21) Appl. No.: 12/543,270

(22) Filed: Aug. 18, 2009

Related U.S. Application Data
(60) Provisional application No. 61/091,108, filed on Aug. 22, 2008.

(51) Int. Cl. H04B 17/00

(52) U.S. Cl. 455/67.11

(57) ABSTRACT

Methods and systems are provided for detecting changes in signaling in a telecommunication system and interpreting the meaning of the changed signal. Methods for detecting a change in a signal in a telecommunication system can include collecting signal information from a sample of telephone numbers, analyzing the signal information to determine whether numbers within the sample are assigned or unassigned, developing rules defining assigned and numbers, and updating the rules. Systems operable to achieve the methods may include call generators, signaling monitors, software employing a signal interpretation algorithm, and a server wherein the call generator is operable to connect to a telephone exchange, and wherein the system is operable to place calls and record signals and optionally audio messages for each call.

### CROSS-REFERENCE TO RELATED APPLICATIONS

This application claims the benefit of U.S. Provisional Patent Application Ser. No. 61/091,108, filed Aug. 22, 2008, the entirety of which is incorporated by reference herein.

### FIELD OF INVENTION

The present invention relates to systems and methods for evaluating signals in communication systems. More particularly, the present invention relates to systems and methods for interpreting and classifying signals in communication systems.

### BACKGROUND OF THE INVENTION

Wireless service providers need to obtain reliable market statistics about their customer-base, as well as those of their competition, in order to make strategic and tactical decisions. Since wireless service providers are competing over the same subscribers, these wireless service providers are not inclined to share customer/subscriber-base information with their competitors. Accordingly, it is necessary for these wireless service providers to obtain reliable measurements of market share information.

Wireless service providers wish to know what percentage of market share that they have had historically and/or currently maintain, and whether they are losing subscribers over time—and if so, who are they losing them to and why. Thus the collected data must be reliable to be meaningful.

Market share information is sometimes available to wireless service providers. This means that information is sometimes available to the service providers regarding what percentage, or share, of the total wireless market they maintain. This “gross” market share information can be gathered in a number of ways. However, there is no system or methodology to efficiently measure service provider market share automatically, electronically or otherwise. Current methods of collecting market share data are cumbersome and time consuming. Moreover, telecommunication networks are always changing because of subscriber behavior, software upgrades in Network Elements (NEs) such as switches, transmission equipment and the like, introduction of new NEs, introduction of new technologies, subscribers, services and regulatory changes, to name a few. These changes can lead to changes in signals, for example, in SS7 signals. In order to calculate market share with any degree of precision, the systems employed to collect the data must be adapted whenever such changes occur. Currently there is no system or method available to automatically detect changes. Moreover, sometimes a change in a system does not result in a change in signaling; other times it does. Therefore it is not necessarily enough to know if a change in the system has occurred, or even what the change was/is.

Accordingly, it would be desirable to provide methods and systems capable of automatically interpreting and classifying signals in communication systems, and detecting changes in signaling.

### SUMMARY OF THE INVENTION

In accordance with at least one aspect the present invention provides a method of defining rules to classify telephone numbers as either assigned or unassigned (or in the case of an unknown response—classifying this for a “re-test”), classifying telephone numbers according to the rules established through prior testing, and/or detecting changes in signaling in a telecommunication system and interpreting the meaning of the changed signal.

In accordance with one embodiment the present invention provides a method for detecting a change in a signal in a telecommunication system comprising collecting signal information from a sample of telephone numbers, defining rules for classifying assigned and unassigned telephone numbers, analyzing the signal information to determine whether numbers within the sample are assigned or unassigned by the carrier by comparing call information to the rules established from prior testing, and updating the rules. In one embodiment the signal information is SS7 signaling.

In another embodiment the method includes defining a sample of numbers to test, initiating a telephone call to each number of the sample, defining rules for classifying assigned and unassigned numbers, monitoring active signaling, sorting the numbers in groups according to an identified status, and for each group of numbers, identifying patterns of signaling by applying the rules. The methods may include observing conditions such as but not limited to the cause ISUP, whether the dialing number was complete, whether there was a reply to the call, whether there were messages of progress of the call, and the information contained in the Backward Call Indicators available in the messages ACM, CPG, ACM and CON. The method may include executing calls using as automatic system with a recording device operable to identify the status of the terminal to which the calls are directed. Information processing may be based on SS7 signaling protocol through an independent connection to a network such as but not limited to a PSTN.

In yet a further embodiment a method may include defining a minimum sample size of numbers to dial, forwarding unknown information that cannot be classified as assigned or unassigned to a retest process until the unknown information reaches a known state, and classifying known information according to the rules defining assigned and unassigned telephone numbers.

In a still further embodiment methods in accordance with the present invention may include applying a statistical model to extrapolate market share information.

In yet further embodiments the present invention provides systems operable to collect and analyze information from a telecommunication system comprising a call generator, a signaling monitor, software employing a signal interpretation algorithm, and a server wherein the call generator is operable to connect to a telephone exchange, and wherein the system is operable to place calls and record signals and audio messages for each call. The signal interpretation algorithm is in one embodiment a SS7 signal interpretation algorithm. The system may be operably connected to at least one PSTN through an interface, such as but not limited to an E1 interface. The system may be operable to process recorded data at the server, and the server may be operable to classify data according to identifying pattern rules. The system may include a central server operably linked to more than one call generator and signaling monitor located in one or more geographic regions, the server operable to collect and process data from the call generators and call monitors.

In accordance with at least one aspect the present invention provides a method for retrieving data from a telecommunication network to calculate the market share of each carrier dynamically, wherein when the network changes, the method adapts itself to the changes.

In another embodiment a system is provide that performs automatic data collection of SS7 signaling, classifies the signal(s) based on selected criteria and processes the data using statistical modeling to report market-share information.

The systems and methods provided can be applied to other communication systems to confirm accuracy thereof using statistical monitors.

Telecommunications market-share data collected using systems and methods in accordance with the present invention can be used to create recurring tests to show trending, gross market customer additions and customer churn.

In one embodiment a method in accordance with the present invention includes defining a minimum sample size of numbers to dial, wherein the minimum sample size assures a low margin of error, preferably less than or equal to 2%, in extrapolated data; classifying the data as known or unknown information; forwarding unknown information to a retest process until the unknown information reaches a known state; classifying known information according to selected rules/criteria that reflect the current status of a particular user/number; and applying a statistical model to extrapolate market share information and related data about a specific market.

### BRIEF DESCRIPTION OF THE DRAWINGS

Other objects and advantages of the invention will become apparent to those skilled in the art upon reading the following detailed description of preferred embodiments, in conjunction with the accompanying drawings, wherein like reference numerals have been used to designate like elements, and wherein:

FIG. 1 is a diagrammatic representation of a general environment within which one or more embodiments of the present invention are employed;

FIG. 2 is a block diagram depicting a method in accordance with at least one embodiment of the present invention;

FIG. 2A is a block diagram depicting a method in accordance with at least one embodiment of the present invention;

FIG. 2B is a block diagram depicting a method in accordance with at least one embodiment of the present invention;

FIG. 2C is a block diagram depicting a method in accordance with at least one embodiment of the present invention;

FIG. 2D is a block diagram depicting a method in accordance with at least one embodiment of the present invention;

FIG. 2E is a block diagram depicting a method in accordance with at least one embodiment of the present invention;

FIG. 2F is a block diagram depicting a method in accordance with at least one embodiment of the present invention;

FIG. 3 is a diagrammatic representation of a system in accordance with at least one embodiment of the present invention;

FIG. 4 is a diagrammatic representation of logic for a system in accordance with at least one embodiment of the present invention; and

FIG. 5 is a diagrammatic representation of a logical architecture of a system in accordance with at least one embodiment of the present invention.

### DETAILED DESCRIPTION OF THE PREFERRED EMBODIMENTS

In the following description, for the purposes of explanation, specific numbers, materials and configurations are set forth in order to provide a thorough understanding of the invention. It will be apparent, however, to a person of ordinary skill in the art, that these specific details are merely exemplary embodiments of the invention. In some instances, well known features may be omitted or simplified so as not to obscure the present invention. Furthermore, reference in the specification to “one embodiment” or “an embodiment” is not meant to limit the scope of the invention, but instead merely provides an example of a particular feature, structure or characteristic of the invention described in connection with the embodiment. Insofar as various embodiments are described herein, the appearances of the phase “in an embodiment” in various places in the specification are not meant to refer to a single or same embodiment.

In order to accurately calculate market share based on information gathered from a telecommunication network, the information collected must be reliable. In view of the fact that signals change for a variety of reasons, it is important that the meaning of a signal is properly interpreted. The present invention provides methods and systems that interpret and adapt to signaling changes in telecommunication networks. Systems in accordance with the present invention are capable of recognizing patterns that could change through time in telecommunications, such as SS7, signaling and translating those patterns into software rules that allow classification of each telephone number as an assigned or unassigned number.

In general, a method of collecting data includes placing calls to a sample of telephone subscribers, obtaining data from the placed calls, interpreting the data and extrapolating the results to the whole population. In accordance with one embodiment, a system is programmed to test phone numbers through responsive signaling. Testing may be conducted in accordance with methods described in U.S. patent application Ser. No. 12/022,763 entitled Method And Apparatus For Measuring Distinctions Between Pre-Paid vs. Post-Paid Customer Base And Market Share For Wireless Communication Service Providers, the entirety of which is incorporated in full by reference herein.

The results of the testing may be used to generate a statistical model. The model may be trended up or extrapolated to show percent of subscriber base, and general market-share.

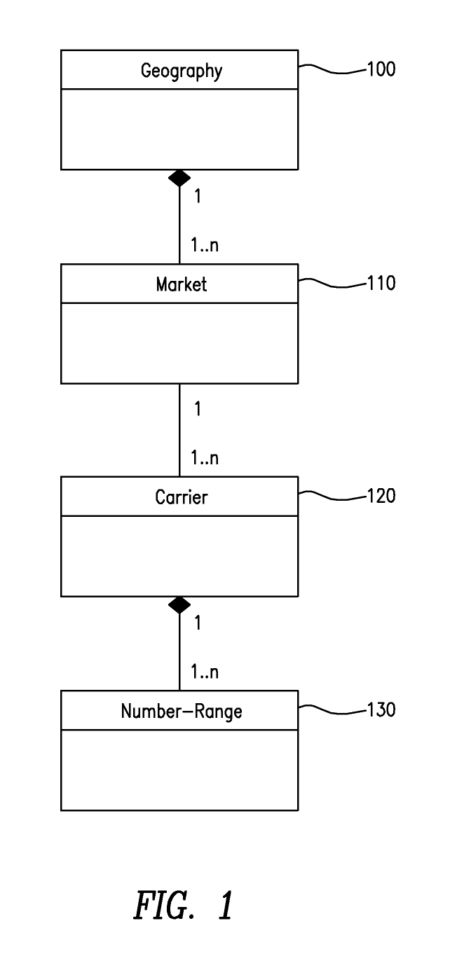

Now referring to the drawings, wherein like numerals indicate like elements, there is shown in FIG. 1 in accordance with at least one embodiment, a simplified block diagram depicting a framework within which the present inventions are employed. A geographic region 100 is segmented into one or more wireless markets 110. Each market 110 is in turn served by one or more wireless service providers (or “carriers”) 120. The combination of a carrier 120 and a market 100 is referred to as a “carrier-market”. Each carrier 120 is allocated ranges of numbers in blocks, identified as carrier number ranges 130. When Local Number Portability (LNP) is not in effect, a number is associated with the market 110 corresponding to the carrier number range 130 of which it is a part. When LNP is in effect, the market 100 may be determined by querying the Local Number Portability (LNP) database.

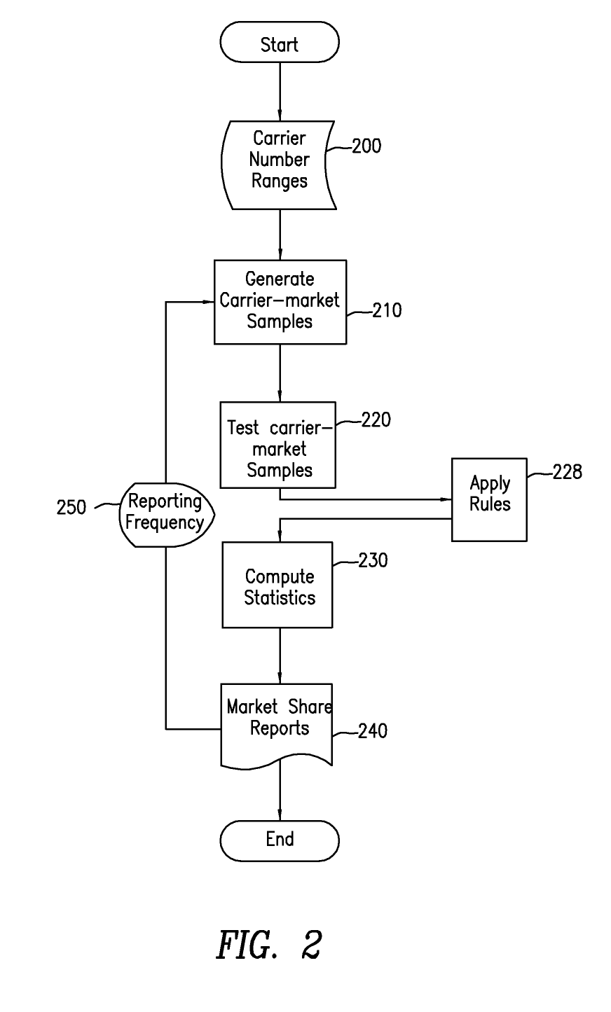

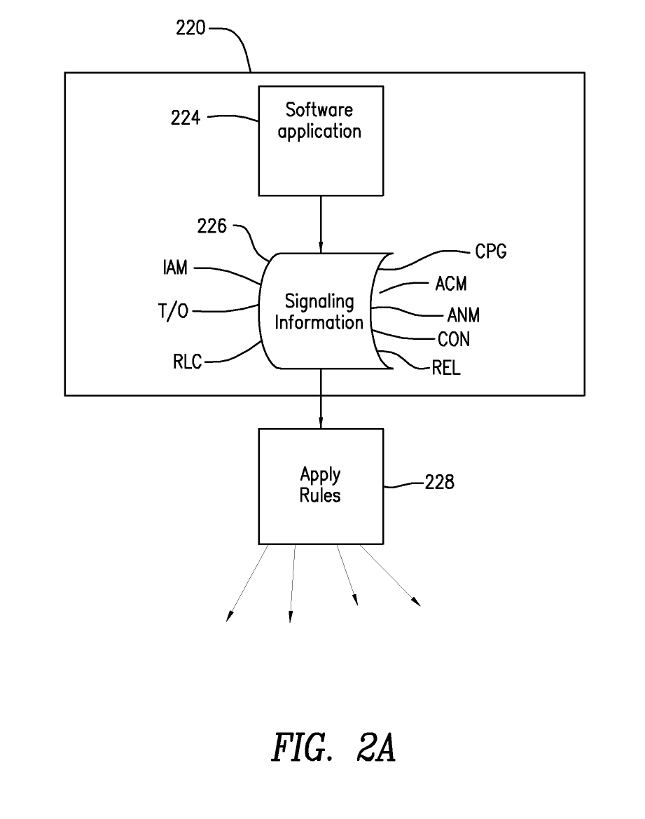

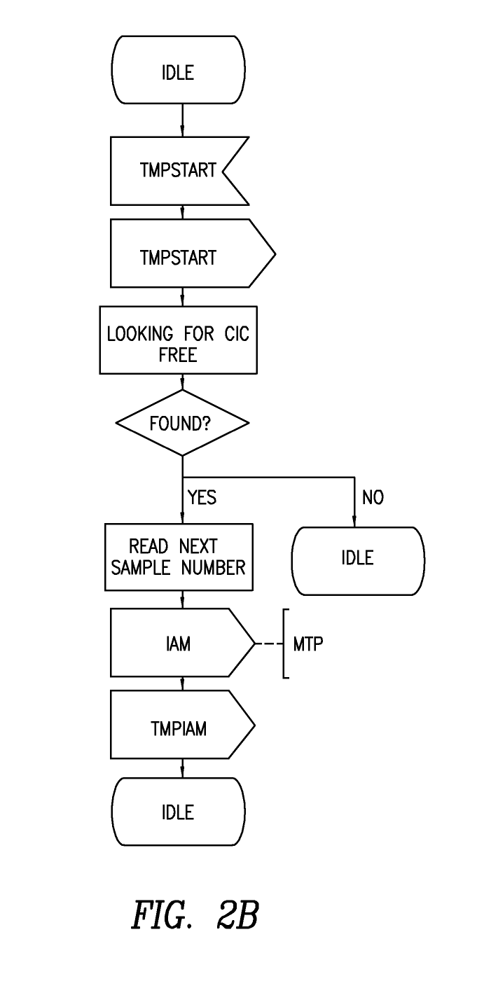

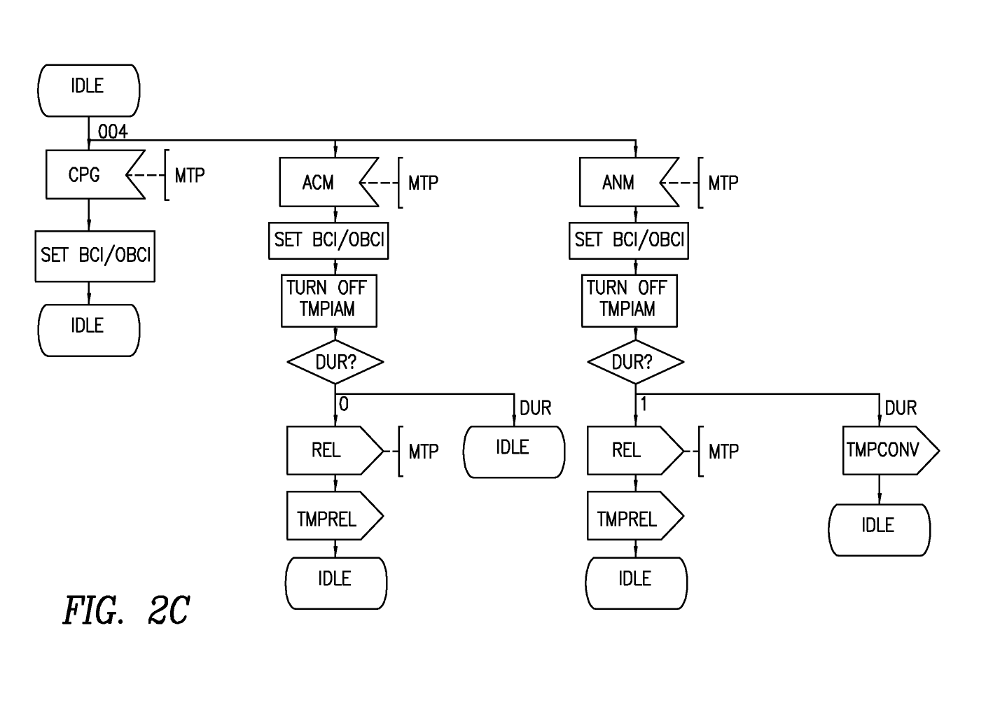

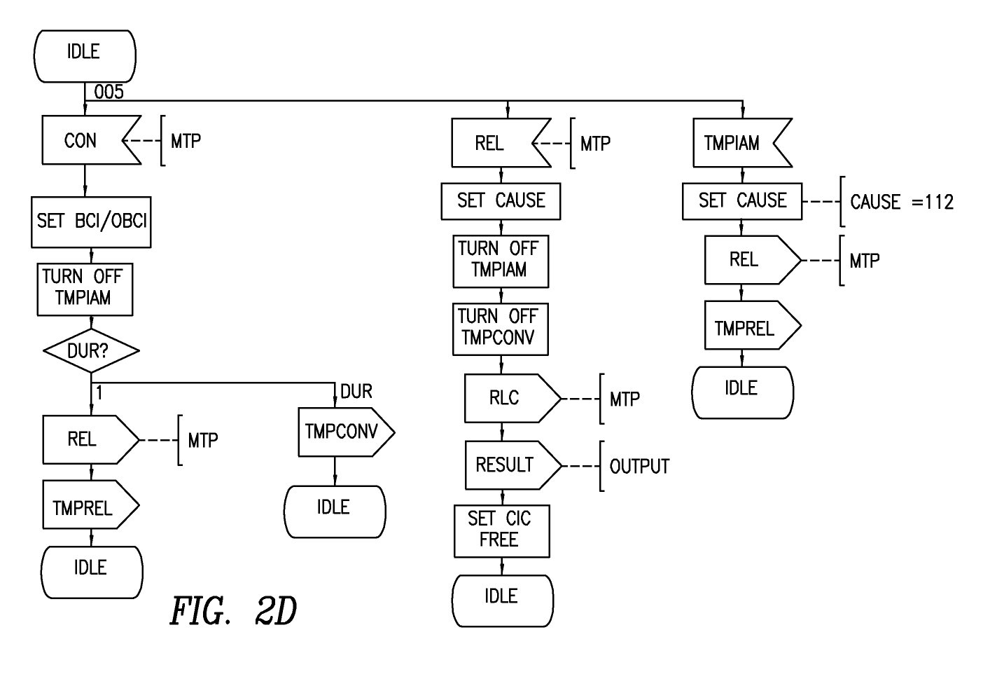

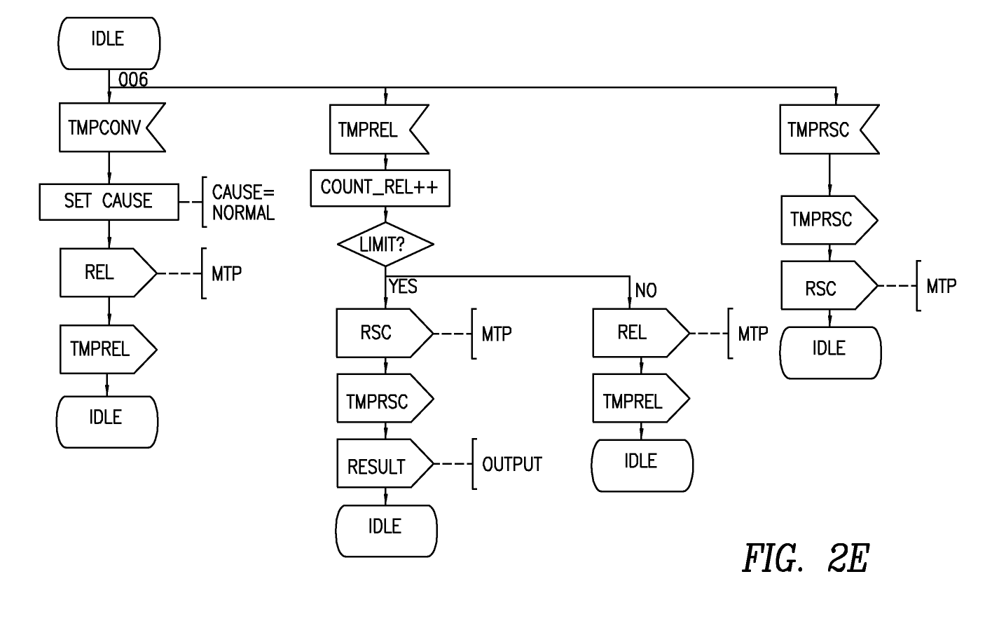

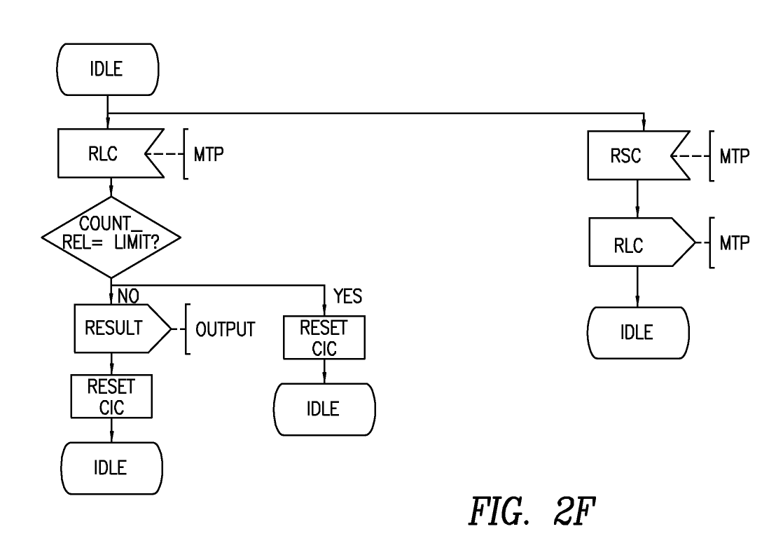

FIG. 2 illustrates a method of collecting and classifying carrier-market information, using the example of a SS7 network. It will be understood the teachings of the present invention may be applied to any telecommunication network.

As is well known in the art, within a SS7 network for example, the point codes are numeric addresses which uniquely identify each signalling point and the Destination Point Code (DPC) identifies the receiving signalling point. In the present invention, publicly available information about carrier number ranges 130 for each carrier-market and the Destination Point Code (DPC) to address each carrier on the SS7 network is collected at step 200. At step 210, for each carrier-market a random, and statistically significant, sample of numbers is generated. The generation of carrier-market samples 210 involves in one embodiment using this information to generate samples of test numbers that accurately represent the population of numbers in each carrier-market. The generated samples include any relevant information that is associated with the line range that the number is contained in, such as the HLR DPC and any knowledge about whether the number is pre-paid or post-paid. Generated samples are stored in a database. At selected intervals, such as but not limited to at least once each reporting period, each sample of numbers is tested at step 220 for each carrier-market for which reporting is provided. Testing 220 generates data to which rules are applied 228 to classify the number. Result information may be stored such as in a database, server, warehouse or the like. At step 230 market statistics are computed, and in step 240 reports are generated using current and historic result information. It will be apparent to those skilled in the art that the reporting frequency 250 may be any suitable frequency such as but not limited to hourly, daily, weekly or the like. In addition, samples can be regenerated as needed.

Now referring to FIG. 2A in an embodiment step 220 is described in further detail, wherein a software application 224 may run tests to generate signaling information 226 which may be categorized for example as CPG (call progress), ACM (address complete), ANM (answer), CON (connection), REL (release), IAM, RLC or T/O (timeout). This information is collected and used to define rules for classifying signals as described in further detail hereinbelow. Now referring in further detail to FIGS. 2A-2F, an exemplary software routine is disclosed for testing telephone numbers/chips to generate signaling information which may be used to classify the number(s).

Methods of generating a sample of test numbers for each carrier-market are known in the art. For example, a database of carrier-market information may be initialized and periodically updated with information about number allocations to markets and with information necessary to address relevant carrier network equipment on the telecommunications network. The process of generating samples may be iterated over the set of all carriers of interest. For each carrier the process of generating samples may then iterate over each market. For each carrier-market the population of numbers allocated to the carrier may be determined using information stored in the carrier database. A randomly selected, statistically significant, subset of numbers within the population may then be generated. The numbers that compose the carrier-market sample are stored in a database for later testing. Relevant attributes for the carrier or number block may be stored with each number. For example, the SS7 Destination Point Code (DPC) of the carrier Home Location Registry (HLR) may be associated with each number.

In most, if not all, markets every telecommunication operator/carrier receives a certain range of numbers it may use to sell services for its subscriber base. These ranges are normally composed of 10,000 numbers. Thus, if an operator has 1,000,000 subscribers, it will have at least 100 ranges. In accordance with one embodiment, a method includes calling a sample of a certain number of subscribers in each range randomly. Preferably this sample is fixed wherein the same numbers called in a given month will be called the next month. Therefore, it will be apparent to those having skill in the art it is preferable that the sample size is adequate to represent the entire population of subscribers.

In a preferred embodiment the sample called is statistically designed to give an error of less than or equal to 2% and a confidence interval of 1%, although it will be apparent to the skilled artisan that any error or confidence interval may be used, the lower the percentage the better. This sample is preferably fixed, as long as the governing telecommunications agency (e.g., in Brazil, the Brazilian Regulatory Agency (ANATEL)) does not offer a new range for the operators. Whenever a new range is attributed to an operator, the original sample is typically increased, and new numbers are randomly selected from the new sample. The size of sample is preferably proportional to the size of the range used by the operator.

It will be further understood that the generation of representative samples is not limited to any single method. For example, it is believed a representative sample may be achieved by generating an even distribution of random numbers within an allocated number block range. However, other factors may be considered and employed in generating a representative sample.

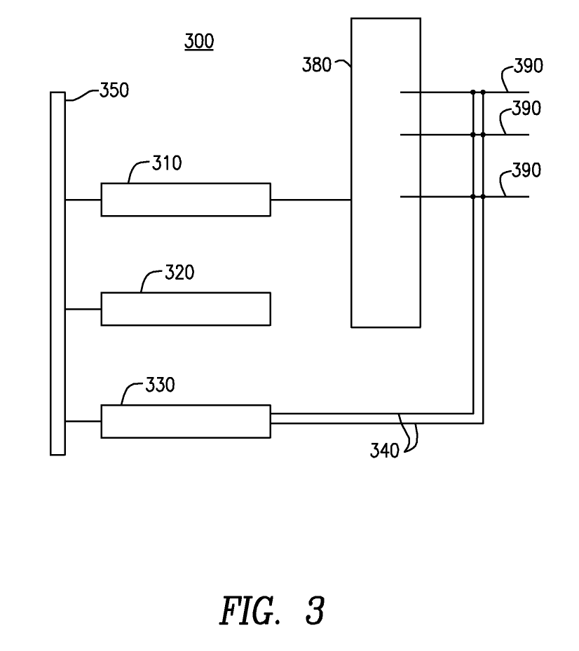

Methods of testing carrier-market samples are described in U.S. patent application Ser. No. 12/022,763 entitled Method And Apparatus For Measuring Distinctions Between Pre-Paid vs. Post-Paid Customer Base And Market Share For Wireless Communication Service Providers, the entirety of which is incorporated in full by reference herein. Reference is in particular drawn to FIGS. 3-6 and the corresponding text. It will be apparent to those skilled in the art that a variety of methods may be employed to determine whether or not a number is assigned to a subscriber. These methods range from the manual or automated calling of numbers to the use of signaling to query the carrier's HLR. Applicable techniques depend on the characteristics of the carrier-market network under test. For example, the methods described in U.S. Pat. No. 6,751,295, incorporated in its entirety herein by reference, may be employed.

The calling process may be performed in any known way, such as manually, such as through a call center, or automatically, such as through a calling machine. In a first embodiment a test call phase is conducted wherein calls are placed automatically and the signaling and the voice responses are recorded and used to define a set of rules for classifying signals. An autodialer is preferably employed to place calls automatically. Results of test calls are recorded in a call log. The call logs are compared to the rules to classify whether the number under test are assigned, unassigned, (classified in places herein using labels “exists”, “does not exist”, respectively) or must be retested. In a preferred embodiment, once significant changes are revealed in market share results, such as but not limited to 3% or 5% increase/decrease in market share, new parsing rules are developed as described in further detail hereinbelow and instituted to account for the changes. It will be apparent to the skilled artisan that the determination or selection of what constitutes a “significant” change is left to the choice of the operator. For example, an operator may decide that when a change is statistically significant, new parsing rules should be instituted.

During test a call to a number may result in a recorded message. These messages typically change over time as described above due to software updates, changes in configuration or inclusion of new equipment. In addition, in some cases, the signal information that will appear in a call log does not provide enough information to classify a number. For this reason, a recording device is implemented to record the signal, i.e., the voice message that is played during a test. The message can be played back and “listened to” by a human or voice recognition software to understand what is contained in the message. The messages obtained may be for example a voice mail box greeting, a system message that the user does not exist or is unassigned, or the like. For example, the voice message may state “this number is out of service” or “this call cannot be completed as dialed” or “the number is busy”, etc. However, the call log entry simply reads “answering machine”, which would without further information incorrectly indicate the number was assigned. Therefore the present invention in one embodiment captures and uses recorded voice information to define rules for classification. The call log can then be accurately processed by applying the rules. In one embodiment a digital voice recorder records all the messages obtained from calls.

Signals may be captured at any location suitable for signal capture. By way of example, signals may be captured in the interface between the generator of calls and the voice switch central office.

In one embodiment a method of the present invention includes generating an input file, which is defined as a file containing the numbers which will be used in a test. The input file is generated from information about the ranges that each telecom service provider has. This information may be obtained from any suitable source, such as but not limited to from the Internet.

This information may used to determine the quantity of telephone numbers in a given range that should be dialed for testing. In one embodiment a minimum number of calls that should be dialed to obtain a statistically relevant result to each telecom service provider should be taken into account. This requires determining the number of different telephone numbers that must be selected from a given range to achieve a statistically valid sample that can be extrapolated to the full range, with a low margin of error/standard deviation, as is known to those having skill in the art. For purposes of the presently disclosed methods, it has been determined that seven calls for every 10,000 numbers is statistically meaningful; doubling the seven calls to fourteen provides increased accuracy. However, if for example, fourteen numbers is selected for a range composed of 10,000 numbers and using 14 numbers per range is determined to not be a statistically adequate number the minimum number is not reached, therefore a determination should be made as to how many numbers must be used from each range. This is a matter of statistical analysis known in the art.

The input file is placed in the server so that the call generator can begin generating calls. The file is optionally configured to include codes such as country code, area code, time interval of verification of free circuits to the allocation of a new call, the time of the start of the test and the time of execution in hours. After the file is configured the test is started. The test may be started in any suitable manner, such as manually through a web interface of the server or automatically, such as by a timer wherein the time of the server may equal a time setting in the file.

In one embodiment a test is conducted to collect information to define rules for classification. Testing conducted after rules are defined can be used to generate a call log which is compared to the rules are defined. The dialed calls generate signals which are recorded in call logs. A new log file may be generated at intervals, such as but not limited to every 15 minutes. Logs may be separated by day and by hour. Call logs are preferably stored in a server.

After the test is over, the information relating to the test is extracted from the call log(s). In one embodiment one or more scripts are executed manually in order to extract the information regarding the log of test execution. The extracted information is used to generate an output file. This output file is processed by the system, preferably using Java. In one embodiment the output file is inserted in a directory where a suitable program reads the data relating to call signaling and inserts the information in a database. Next, rules are applied to the data relating to call signaling.

Each performed call is then registered in the database with its respective classification arrived at by application of the rules, for which the process of defining is discussed in further detail below. The system may optionally further employ Java to separate and/or correlate results for each telecom provider on a per-provider basis.

A call may be classified in three different classifications: Exist, Does Not Exist and Retest. The skilled artisan will recognize that these classification labels Exist, Does Not Exist and Retest may be named anything suitable for the purposes of carrying out the embodiments disclosed herein. The calls classified as Retest are inserted in a file that will be used to perform a redial. This process of redialing is performed until the percentage of numbers to retest does not exceed some preselected percentage of the total size of the sample of each telecom provider. For example, a suitable percentage may be 5% of the total size of the sample of each telecom service provider.

When the redialing process is complete, the numbers are passed through a statistical model which provides the number of subscribers, churn, adds and other data that may include relevant data for market share and market dynamics. These data may be used to update current market data, and can be provided to client such as telecommunication carriers.

### Defining Rules for Classifying Signals

The rules for classifying signals are defined starting from the identification of the patterns of telephone signaling for calls. With the application of the rules under a test, it is possible to classify the tested numbers in one of the following status: RE-TEST: the information obtained in the telephone signaling are not sufficient to determine if the number does exist or not; EXIST: the information obtained in the signaling is sufficient to determine that the number is assigned to a subscriber; and DOES NOT-EXIST: the information obtained in the signaling is sufficient to determine that the number does not is not currently assigned to a subscriber. The behavior of the telephone signaling network may vary according to many factors such as the point where the signaling is monitored; the selected operator to conduct the call; the inclusion/exclusion of elements of the network; the exchange of technology of the equipment of the network; the reconfiguration of equipments; and the like. The following procedures are used to determine rules: 1) define a sample of numbers for test; 2) with the monitoring of active signaling, effect a telephone call to each number under test; each call may be executed using a conventional device or an automatic system with means for recording, so that it is possible to clearly identify the status of the terminal for which the call is directed; 3) separate the numbers in groups, according to the identified status; 4) to each group of numbers, identify the patterns of signaling observing at least some of the following conditions: A) the cause ISUP (parameter Cause Indicator); B) if the dialing number was complete (messages ACM—Address Complete and CON—Connect); if there was reply to the call (messages ANM—Answer and CON—Connect); C) if there were messages of progress of the call (message CPG—Call Progress); D) the information contained in the parameter BCI (Backward Call Indicators) available in the messages ACM, CPG, ACM and CON. By way of example and not limitation, signals considered for definition/appliance of the RULES may include:

| | |
|---|---|
| IAM | Initial Address |
| ACM | Address Complete |
| CPG | Call Progress |
| ANM | Answer |
| CON | Connect |
| REL | Release |
| RLC | Release Complete |

The following Example illustrates how the signals observed can be used to assign rules for classifying numbers.

### Example 1

Test calls were made to Chile, using the CSP 15 (Telefônica), generated from the website of Aerotech in San Paulo. The following rules (under the heading “ID” is the rule; the corresponding description of the rule is under the heading “Description”) were obtained:

Rules for the cases “RE-TEST”

| ID | Description |
|---|---|
| RT1 | REL <> {1, 16; 31} |
| RT2 | There is not ANM + REL = {16} after 59000 ms (direction B->A) |
| RT3 | There is not ANM + there is not ACM + REL = {31} |

Rules for the cases “EXIST”

| ID | Description |
|---|---|
| RE1 | There is ANM |
| RE2 | There is not ANM + there is ACM (BCI_CAT = NO) + there is |
| | “n” CPG (BCI_CAT = NO) + REL = {31} |
| RE3 | There is not ANM + there is ACM (BCI_CAT = NO) + there is |
| | “n” CPG |
| RE4 | There is not ANM + there is ACM (BCI = SUB_FREE_CHG) + |
| | there is 1 CPG (BCI = FREE_CHG) + REL = {31} |
| RE5 | There is not ANM + there is ACM (BCI = SUB_FREE_CHG) + |
| | there is not CPG + REL = {31} |

Rules for the cases “DOES NOT-EXIST”

| ID | Description |
|---|---|
| RNE1 | There is not ANM + REL = 1 (direction A->B) |
| RNE2 | There is not ANM + there is not ACM + REL = {16} |
| RNE3 | There is not ANM + there is ACM (BCI_CAT = NO) + |
| | there is not CPG + REL = {16} |
| RNE4 | There is not ANM + there is ACM (BCI_CAT = NO) + |
| | there is not CPG + REL = {31} |
| RNE5 | There is not ANM + there is ACM (BCI = |
| | SUB_FREE_CHG) + there is “1” |
| | CPG (BCI = “”) + REL = {31} |
| RNE6 | There is not ANM + there is ACM (BCI = |
| | SUB_FREE_CHG) + there is not |
| | CPG + REL = {16} |

It will be apparent to those skilled in the art that any labeling convention can be employed for the rules identification. In further embodiments procedures for validation and maintenance of rules may be used and can include for example as follows:
i) Validation of the RULES through auditing: for each RULE (of the types “EXIST” and “DOES NOT EXIST”) to select a sample of numbers which case test were classified by this RULE and effect a test call to confirm if the classification is correct.
ii) Validation of the RULES through statistical analysis: analyze the percentage of classified numbers in each RULE for a given length of time, in a way to identify abrupt variations in the appliance of a specific RULE, which can identify a change of behavior of the signaling in the network. For example, it may be the case that over time the variation for each rule from one month to the next is small (for example, from 8 to 10%). If one or more rule presents a monthly variation above 10% the rules and signaling should be reviewed.
   In one embodiment an autodialer may be employed with for example a cellular interface (that can both make the calls and receive SMS messages), that is trained to recognize the SMS originating number when and if it receives one, and then classifies the number correctly. In another embodiment, a VoIP GSM gateway may be employed to enable direct routing between IP, digital, analog and GSM networks. In another embodiment a GSM board can be placed directly in a VoIP PBX, such as but not limited to an Asterisk PBX (free PBX) to generate the calls. Fixed cellular terminals enable companies to significantly reduce the money they spend on telephony, especially the money spent on calls from IP to GSM. Through least cost routing the gateways select the most cost-effective telephone connection. The gateways check the number which is dialed as well as rate information which is stored in an internal routing table. Because several SIM cards and GSM modules are integrated within the VoIP GSM gateway it is able to make relatively inexpensive GSM to GSM calls instead of expensive IP to GSM calls.

It may be desirable to employ methods of extracting information from telecommunication carrier billing systems. To this extent U.S. patent application Ser. No. 12/022,763 entitled Method And Apparatus For Measuring Distinctions Between Pre-Paid vs. Post-Paid Customer Base And Market Share For Wireless Communication Service Providers, the entirety of which is incorporated in full by reference herein, is instructive, with specific reference to FIG. 7 and the corresponding text.

Now referring to FIG. 3, a system 300 operable to test numbers in accordance with the present invention includes a call generator 310, server 320 and signaling monitor 330 interconnected via a network 350, preferably an IP network. Call generator 310 is connected to a telephone exchange and generates a call to a number. Call generator 310 may be an autodialer or any suitable device for initiating calls as will be apparent to those skilled in the art. Call generator 310 may be programmed to initiate calls to numbers based on any criteria, such as but not limited to randomly, according to a list, according to programming installed on the generator 310 or server 320, in response to input from monitor 330, in conjunction in accordance with the methods and techniques set forth above or the like. Call generator 310 may be a conventional device or an automatic system with means for recording, so that it is possible to clearly identify the status of the terminal for which the call is directed. System 300 includes a recording device for recording the result of calls made during testing to assist in the step of defining rules for voice messages, as discussed hereinabove. The system 300 optionally includes an automatic system of voice recognition to recognize interpret the voice message so that rules can be defined automatically. It will be apparent to those skilled in the art that messages can also be listened to by a human, interpreted manually, and the rules defined thereby.

Server 320 may be programmed with instructions for the call generator 310 and/or the signaling monitor 330 in accordance with the techniques and methods described herein. Server is operable to process information in accordance with the techniques and methods described herein.

Signaling monitor 330 is connected via signaling probes 340 to one or more telecom operators 390 via a suitable transmission connection such as a T1, E1 or other line using a suitable transmission format for collecting data. Data is collected and sent to server 320 for processing. It will be apparent to those skilled in the art that the call generator 310, server 320 and or signaling monitor 330 may be contained in a single unit.

By way of example, in one embodiment a suitable system includes the LCG3000 available from Labcom Systems of Campinas, which is operable as an endpoint of a SS7 ISUP signaling link over one 64 Kbps channel in an E1 link. The LCG3000 generates and monitors of telephone calls in E1/T1 links for telephonic signaling. The device enables identification of failures in the links and provides a platform for analysis of signaling in different layers of the protocol. The LCG3000 can be used in connection with the present invention to generate and/or monitor the artificial traffic for the system testing during the activities of implantation/maintenance, for evaluation of quality and independent auditing of interconnections for identification of electric problems and compatibility.

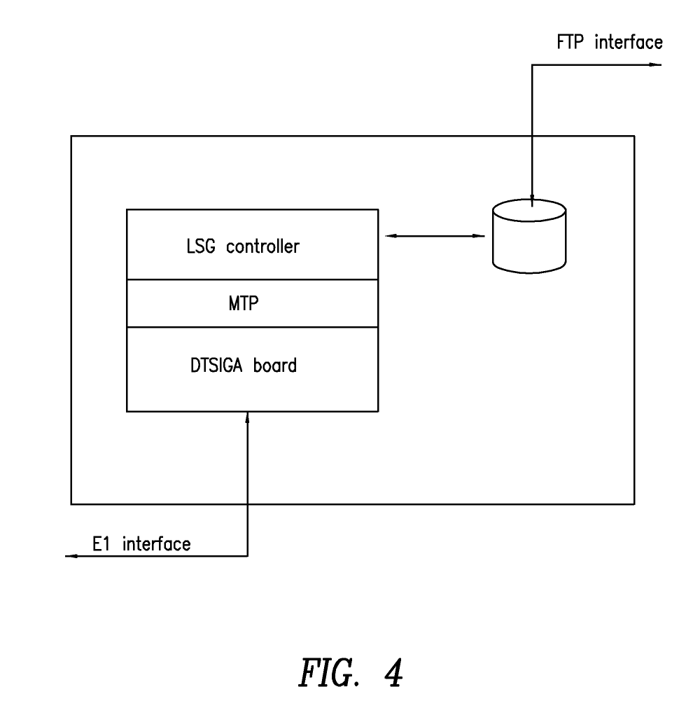

The desired software application runs in a server 320 and commands the call generation in call generator 310. For purposes of this example the LCG3000 is a combined call generator 310 and signaling monitor 330. The LCG3000 and the server 320 are both connected to the same IP network. The interface LCG/Server works on batch file mode. The server transmits (FTP) a batch file to the LCG3000 and at the end of processing the LCG3000 writes a result file to be downloaded by the server. Exemplary software blocks inside the LCG3000 are shown in FIG. 4. The DTSIGA board drives one ISUP signaling channel in the E1 interface. The software MTP treats the physical level (MTP1), the link level (MTP2) and the network level (MTP3) of the SS7 stack below the ISUP application part. The software MTP attends the ITU-T rec. Q.703, Q.704, Q.705, Q.706 and Q.707, with the modifications allowed by the rec. Q.710. The LCG3000 controller reads the input file in the ftp:/input directory, does the job and writes back a result file in the ftp:/output directory.

In one embodiment the LCG3000 at a designated start time dials each number in sequence up to the number of available free channels, then, after a given time period, repeats the procedure beginning with the next number and so on during the duration of the test. The test ends after the last number. The test may be suspended after a given time interval and resumes at a given next start time. An output file reports information to the server.

### Example 2

Input file format: The input file is a text file with 3 types of lines: comment lines, information line, header line and called number lines.

Comments line: Any line starting with “#” at the beginning of the file is ignored and can be used as a comment line.

Information line: The Information line has a free format. Everything in the information line is copy to the first line of output file.

Header Line: the Header has the Format:

<country code>, <national area code>, <call interval>, <start hour>, <duration><LF> where <country code> is a decimal integer that identifies the country, <national area code> is a decimal integer that identifies the telephone area, <call interval> is a decimal integer that gives the time in seconds between call attempts, <start hour> is a decimal integer that gives the is hour that the call attempts will be started, <duration>, is a decimal integer that gives the duration, in hours, of call attempts, <LF>, is the end of line character.

Called number line: The Called number line has the format: <sample_id>, <calling number>, <called number><LF> where <sample_id> is a string with 10 characters (max) that gives information about that sample <calling number> is a decimal integer that gives the subscriber number who is originating the call, <called number> is a decimal integer that gives the subscriber number to be dialed during call attempts, <LF>, is the end of line character.

Any number of called number lines follows the header line. The LCG at the <start hour> dials each <called number> in sequence up to the number of available free channels, then, after <call interval>, repeats the procedure beginning with the next <called number> and so on during the <duration> of test. The test ends after the last called number line. The test is suspended after <duration> and resumes at the <start hour> in the next day.

### Example 3

#LCG3000 input file example
#call interval: 300 seconds
#start: 22 h
#duration: 2 hours
#number to be dialed in sequence follow

### Test 001—Operator XXX—Region nn 55,11,300,22,2

### Sample_{—}001,1149115004,0151932897479

### Sample_{—}001,1149115004,0151155713415

### Sample_{—}001,1149115004,0152133445566

Output file format: The output file is a text file with 2 types of lines: information line and output lines.

Information line: The Information live has a free format. This line is a copy of information line present in the input file.

Output line <sample_id>, <calling number>, <country code>, <national area code>, <called number>, <release code>, <optional release code>, <backward call indicators>, <optional backward call indicators>, <time>, <elapsed time>, <LF> where <sample_id> is a string with 10 characters (max) that gives information about that sample. This value is a copy of same information present in the input file. <calling number> is a decimal integer that gives the subscriber number who is originating the call, This value is a copy of same information present in the input file. <country code> is a decimal integer that identifies the country, <national area code> is a decimal integer that identifies the telephone area, <called number> is a decimal integer that gives the subscriber number dialed, <release code> is a decimal integer from 1 to 127 that gives the release code of the call as defined in ITU-T rec. Q.850. Two additional values are 0: Circuit Reset Signal Received and 112: No response to IAM. <optional release code> is a decimal integer from 1 to 127 that gives the release code of the call as defined in ITU-T rec. Q.850. The “0” value is used in the absence of the optional parameter; <backward call indicators> is a decimal integer from 0 to 65535 as described in ITU-T rec. Q.763; <optional backward call indicators> is a decimal integer from 0 to 255 as described in ITU-T rec. Q.763. The 0 value is used in the absence of the optional parameter. <time> timestamp when the register was recorded in the output file (format: the number of milliseconds since the epoch, i.e., since 1970-01-01 00:00:00:000 UTC. <elapsed time> The number of milliseconds since the start of the call.

### Example 4

### Test 001—Operator XXX—Region nn

### Sample_{—}001,1149115004,55,11,0151132897479,16,0,3,0,1183412693001,1001

### Sample_{—}001,1149115004,55,11,0152133445566,16,0,3,0,1183412694002,2021

### Sample_{—}001,1149115004,55,11,0151132897479,112,0,0,0,1183412695021,2111

### Sample_{—}001,1149115004,55,11,0151155713415,112,0,0,0,1183412696111,2005

### Sample_{—}001,1149115004,55,11,0152133445566,16,0,5,0,1183412697006,2077

Configuration File

The system has a configuration file where the following parameters are configured or defined by default. The configuration file is a sequence of lines each one with the format: <parameter name><space><parameter value><LF>

CIC_MIN First Circuit identification Code. Integer value from 0 to 4095. Default value: 1.

CIC_MAX Last Circuit identification Code. Integer value from 0 to 4095. Default value: 30.

CPC Calling Party's Category. Integer value from 0 to 255. Default value: 10 (ordinaty calling subscriber).

DPC Destination Point Code. Integer value from 0 to 16383. Default value=Origination Point Code of the received SLTM message.

NCI ISUP Nature of Connection Indicators. Integer value from 0 to 255. Default value=0.

NOA_A Nature of Address of Calling Party Number. Integer value from 0 to 127. Default value=3 (national number).

NOA_B Nature of Address of Called Party Number. Integer value from 0 to 127. Default value=3 (national number).

OPC Originating Point Code. Integer value from 0 to 16383. Default value=Destination Point Code of the received SLTM message.

PRES_IND Address presentation restricted (Pres. Restric.) indicator for the calling party number. Integer value from 0 to 3. Default value=1 (presentation restricted).

REDIRECTION Redirection information parameter in the IAM message. Values: 1 (parameter present with value 1-1 octet), 0 (parameter not present). Default: 1

SCREEN_IND Screening indicator for the calling party number. Integer value from 0 to 3. Default value=1 (user provided, verified and passed).

SLS Signaling Link Selection code. Integer value from 0 to 15. Default value=0.

SSF SCC7 Sub-service Field. Integer value from 0 to 3. Default value=SSF of the received SLTM message.

TMR ISUP Transmission Medium Requirements. Integer value from 0 to 255. Default value=3 (3.1 KHz audio).

Functioning

In accordance with one embodiment, every hour the LCG checks for a new input file and reads it. During the test period this check is suspended. If the call attempts should start at the present hour, the LCG either opens an output file with the name related to the present hour and starts generating call attempts or resumes from last day, if the input file did not reach the end the previous day. The first call attempt (IAM message to the MTP interface) is directed to the first called number in the first free circuit (channel) (CIC and other ISUP parameters are defined in a configuration file). Additional call attempts are tried with the next called number and the next free circuits until all free circuits are seized. If a message REL is received, the LCG sends a RLC message to the MTP interface and writes a line with the release cause in the output file. In this line the backward and the optional backward call indicators are set to 0. If an ACM or CPG message is received the backward and optional backward call parameters, if present, are set. Reception of ACM and CPG in the same call causes the backward call indicators of both signals to be “ORed”. If a ANM or CON message is received, the LCG sends a REL message to the MTP interface with release cause 16 (normal call clearing) and, after the receive of a RLC message, writes a line in the output file with release code 16, optional release code, and backward and optional backward call as received. After the time interval another set of call attempts are made with the next set of called numbers and all free circuits. At the end hour the call attempts are suspended. At any time if the MTP link goes out of service, the call attempts are suspended. At the end of the input file the call attempts stop. Call attempts start again the next day from the beginning. If the MTP does not receive the RLC message, it transmits another REL at each and every minute. At the 5^{th} trial, the REL message is substituted by the RSC (Reset Circuit) message and the retrial time is changed to 5 minutes.

Once information has been collected regarding carrier market samples in accordance with the aforementioned techniques, statistics are generated using the information, such as but not limited to subscriber churn and gross additions. Statistics may be generated on server 320 or a separate computing device. It will be recognized that some or all of these statistics may be calculated, and may be calculated in any order.

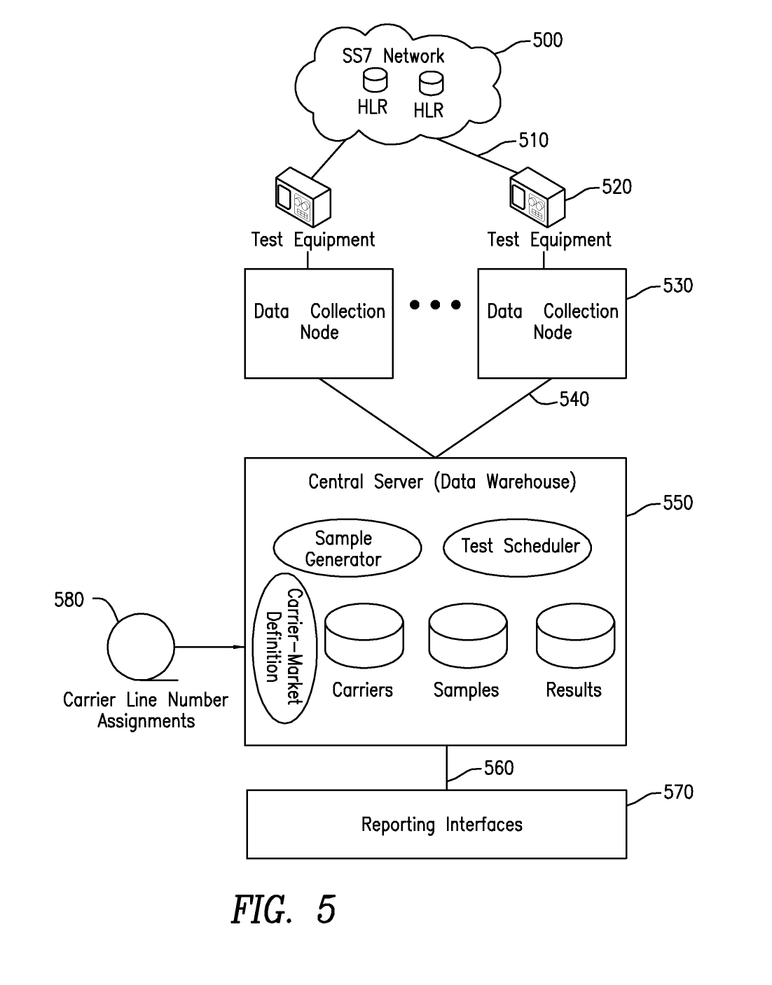

Now referring to FIG. 5, illustrated is an embodiment of a logical architecture of a system which would benefit from the teachings of the present invention, and which can generate market reports. Such a system includes data collection components 520, 530, a central server 550, and reporting mechanisms 570. The data collection components include an SS7 interface 520, or internal card or external test equipment, that interfaces (510) to the SS7 network 500. As will be apparent to the skilled artisan, there are a variety of possible ways that the test equipment can be connected such as but not limited to a direct A link connection to a Signal Transfer Point (STP) or using a monitoring link to existing A links. Data collection nodes 530 serve as controllers of the test equipment coordinating the testing of a sample of numbers. It is contemplated that there may be a one-to-one correspondence between data collection nodes 530 and test equipment or a single node could control multiple pieces of test equipment. Additional data collection nodes 530 and test equipment can be added as necessary to meet the throughput/scalability requirements of the system. Data collection nodes 530 are connected via a network connection 540 to a central server 550 which uses publicly available data about wireless service provider line number range assignments 580 to generate, maintain, and store carrier-market samples. The central server 550 preferably schedules and load-balances the execution of carrier-market sample tests across data collection nodes 530. The central server 550 stores test results for the period necessary to generate required reports. The central server 550 fulfills the role of test controller and data warehouse. In accordance with one embodiment the system may provide any variety of reporting interfaces 570, such as but not limited to using existing Online Analytical Processing (OLAP) mechanisms to providing customers with direct data feeds.

A suitable statistical model that can be employed to generate market dynamics report data may include steps of generating a list containing all the samples (mobile phone numbers), and processing the list on a server generating SS7 signaling messages. The messages are processed in a program, such as one developed with Java, that contains rules that are operable to classify the status of each phone number. Once the numbers are classified, the subscribers total, the churn and the additions can be calculated.

One suitable algorithm that can be employed to estimate subscribers is the following: Subscribersₙ=Pₐ×N where: Pₐ=(active linesₙ)/(active linesₙ+inactive linesₙ+unknown linesₙ). N is the total of lines that the carrier has, including active and free lines.

Subscriber churn is generally recognized as a measurement of how many subscribers terminate wireless service with a particular wireless service provider during a specific time interval. This time interval is typically a month or a quarter. In one embodiment, data collected for example for a list of specific test MINs on January 1 is compared to data collected for the same list of test MINs measured on February 1. For each test MIN it is known whether or not the MIN was assigned or unassigned on January 1, and assigned or unassigned on February 1. Thus, subscriber churn is calculated using the number of test MINs which were assigned on January 1, but were determined to be unassigned on February 1. The result of this comparison is divided by the sample rate to estimate the total churn for each wireless service provider.

In addition, other churn statistics can be calculated, as discussed in U.S. Pat. No. 6,751,295, with specific reference to FIGS. 21A-21C and the text directed thereto, incorporated herein by reference.

In accordance with one embodiment, to calculate churn, it is preferred to have historical data of two months. The total of active numbers at the first month (Tₙ₋₁) is verified, and then the numbers in this list that turned inactive the following month (Tₙ) is verified. The following algorithm can be applied to calculate the percentage of churn: Churn percentageₙ=(Tₙ/Tₙ₋₁)*100 where: Tₙ₋₁ is the total of active numbers in the month N-1. Tₙ is the total of numbers that turned inactive in the month N. This percentage in the subscribers total of the month N-1 is applied to get the estimated count of lost subscribers in the month N, that can be expressed with the following algorithm: Churn countₙ=(Churn percentageₙ/100)*Subscribersₙ₋₁ Where: Churn percentageₙ is the percentage calculated previously. Subscribersₙ₋₁ is the total of subscribers in the month N-1 (previous month).

Subscriber gross adds is a measurement of how many subscribers begin wireless service during a specific time interval, the time interval typically being a month or a quarter. To determine gross adds, a comparison of data from one test period (such as for example January 1) to another (February 1) is made. It should be recognized that a wireless service provider could have added new line ranges to accommodate expansion after the January 1 measurements but before the February 1 measurements. Thus, a modified set of test MINs will include the test MINs used for the January 1 measurements plus a given sampling rate (for example, 5%) times the number of MINs in the new line range. For example, if wireless service provider A adds a range of 10,000 new MINs in January, the February modified test MINs would include an additional 500 MINs, i.e., 10,000 new MINs times the 5% sampling rate. Thus, the present invention can determine the number of test MINs which were unassigned on January 1 but were assigned on February 1.

To calculate the estimated gross add MINs, the number of MINs unassigned on January 1 which were assigned on February 1 is divided by the sampling rate. As an example, wireless service provider A and wireless service provider B had 73 and 57 test MINs, respectively, unassigned on January 1 and assigned on February 1. Using the 5% sampling rage, the estimated gross adds of MINs for wireless service provider A is 1460 (i.e., 73.div.0.05), and the estimated gross adds of MINs for wireless service provider B is 1140 (i.e., 57.div.0.05). In addition, other gross add formulas may be employed. For example, the gross add formula can be modified such that the denominator represents the average of the subscribers at the beginning of the measurement period and the end of the measurement period. A wireless service provider's subscriber gross add share can also be calculated. For example, wireless service provider A has a subscriber churn share is 56.15%, i.e., 1460.div.(1460+1140). To calculate the gross add percentage for each wireless service provider over the one month period, the estimated gross add MINs is divided by the number of estimated MINs for that wireless service provider at the beginning of the period. Accordingly, the gross add percentage for wireless service provider A is 10.90% (i.e., 1460.div.13,400), and the gross add percentage for wireless service provider B is 6.70% (i.e., 1140.div.17,000).

In one embodiment, additions may be calculate using the following algorithm: Adds countₙ=Subscribersₙ−(Subscribersₙ₋₁−Churn countₙ) Where: Subscribersₙ is the total of subscribers in the month N. Subscribersₙ₋₁ is the total of subscribers in the month N-1. Churn countₙ is the Churn count in the month N.

To obtain the percentage of the additions the following algorithm can be applied: Adds percentageₙ=(Adds countₙ/Subscribersₙ₋₁)*100 Where: Adds countₙ is the Adds count of the month N. Subscribersₙ₋₁ is the total of subscribers in the month N-1.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. The scope of the invention is given by the appended claims, rather than the preceding description, and all variations and equivalents which fall within the range of the claims are intended to be embraced therein.

The following tables contain definitions of ISUP acronyms.

ISUP Message Table

| Acronym | Message |
|---|---|
| ACM | Address Complete |
| ANM | Answer |
| BLO | Blocking |
| BLA | Blocking Acknowledgment |
| CMC | Call Modification Completed |
| CMRJ | Call Modification Reject |
| CMR | Call Modification Request |
| CPG | Call Progress |
| CGB | Circuit Group Blocking |
| CGBA | Circuit Group Blocking Acknowledgment |
| CQM | Circuit (Group) Query |
| CQR | Circuit (Group) Query Response |
| GRS | Circuit Group Reset |
| GRA | Circuit Group Reset Acknowledgment |
| CGU | Circuit Group Unblocking |
| CGUA | Circuit Group Unblocking Acknowledgment |
| CRM | Circuit Reservation |
| CRA | Circuit Reservation Acknowledgment |
| CVR | Circuit Validation Response |
| CVT | Circuit Validation Test |
| CSVR | CUG Selection and Validation Request |
| CSVS | CUG Selection and Validation Response |
| CRG | Charge Information |
| CFN | Confusion |
| CON | Connect |
| COT | Continuity |
| CCR | Continuity Check Request |
| DRS | Delayed Release |
| EXM | Exit |
| FAC | Facility |
| FAA | Facility Accepted |
| FAD | Facility Deactivated |
| FAI | Facility Information |
| FRJ | Facility Reject |
| FAR | Facility Request |
| FOT | Forward Transfer |
| IDR | Identification Request |
| IRS | Identification Response |
| INF | Information |
| INR | Information Request |
| IAM | Initial Address |
| LPA | Loop Back Acknowledgment |
| NRM | Network Resource Management |
| OLM | Overload |
| PAM | Pass-along |
| REL | Release |
| RLC | Release Complete |
| RSC | Reset Circuit |
| RES | Resume |
| SGM | Segmentation |
| SAM | Subsequent Address |
| SUS | Suspend |
| UBL | Unblocking |
| UBA | Unblocking Acknowledgment |
| UCIC | Unequipped CIC |
| UPA | User Part Available |
| UPT | User Part Test |
| USR | User-to-user Information |

ISUP Parameter Table

| Acronym | |
|---|---|
| | Access Delivery Information |
| | Access Transport |
| | Automatic Congestion Level |
| BCI | Backward Call Indicators |
| Cause | Cause Indicators |
| OBCI | Optional Backward Call Indicators |

Glossary of SS7 Acronyms

| Acronym | |
|---|---|
| ASE | Application Service Element |
| BIB | Backward Indicator Bit |
| BSN | Backward Sequence Number |
| CCITT | International Telegraph & Telephone Consultative |
| | Committee |
| CCS | Common Channel Signalling |
| CIC | Circuit Identification Code |
| DPC | Destination Point Code |
| DUP | Data User Part |
| FCS | Frame Check Sequence |
| FIB | Forward Indicator Bit |
| FSN | Forward Sequence Number |
| FISU | Fill-In Signal Unit |
| GTT | Global Title Translation |
| ISP | Intermediate Service Part |
| ISPC | International Signalling Point Code |
| ISUP | ISDN User Part |
| LI | Length Indicator |
| LSSU | Link Status Signal Unit |
| MSU | Message Signal Unit |
| MTP | Message Transfer Part |
| NSP | Network Services Part |
| OMAP | Operations and Maintenance Application Part |
| OPC | Origination Point Code |
| OSI | Open Systems Interconnection |
| SANC | Signalling Area Network Code |
| SCCP | Signalling Connection Control Part |
| SEP | Signalling End Point |
| SF | Status Field |
| SI | Service Indicator |
| SIF | Signalling Information |
| SIO | Service Information Octet |
| SLC | Signal Link Code |
| SLS | Signal Link Selection |
| SNM | Signalling Network Management |
| SNT | Signalling Network Testing |
| SP | Signalling Point |
| SPC | Signalling Point Code |
| SPR | Signalling Point W/SCCP Relay function |
| SSF | Sub-Service Field |
| STP | Signal Transfer Point |
| SU | Signal Units |
| TC | Transaction Capabilities |
| TCAP | Transaction Capabilities Application Part |
| TUP | Telephone User Part |

What is claimed is:

1. A method for detecting a change in a signal in a telecommunication system comprising: collecting signal information from a sample of telephone numbers, analyzing the signal information to determine whether numbers within the sample are assigned to a subscriber or are unassigned, developing rules defining assigned and unassigned numbers, and updating the rules.

2. The method according to claim 1 wherein the signal is a SS7 signal.

3. The method in accordance with claim 1 comprising defining a sample of numbers to test, initiating a telephone call to each number of the sample, monitoring active signaling, sorting the numbers in groups according to an identified status, and for each group of numbers, identifying patterns of signaling.

4. The method according to claim 3 comprising observing at least one condition selected from: the cause ISUP, whether the dialing number was complete, whether there was a reply to the call, whether there were messages of progress of the call, and the information contained in the Backward Call Indicators available in the messages ACM, CPG, ACM and CON.

5. The method according to claim 3 wherein each call is executed using as automatic system with a recording device operable to identify the status of the terminal to which the call is directed.

6. The method according to claim 1 comprising processing information based on SS7 signaling protocol through an independent connection to a PSTN network.

7. The method according to claim 1 comprising defining a minimum sample size of numbers to dial, forwarding unknown information that cannot be classified as assigned or unassigned to a retest process until the unknown information reaches a known state, and classifying known information according to the rules defining assigned or unassigned numbers.

8. The method according to claim 1 comprising applying a statistical model to extrapolate market share information.

9. A system operable to collect and analyze information from a telecommunication system comprising at least one call generator, at least one signaling monitor, software employing a signal interpretation algorithm, and at least one server wherein the at least one call generator is operable to connect to a telephone exchange, and wherein the system is operable to place calls and optionally record signals and audio messages for each call.

10. The system according to claim 9 wherein the signal interpretation algorithm is a SS7 signal interpretation algorithm.

11. The system according to claim 9 operable to connected to at least one PSTN through an interface.

12. The system according to claim 11 wherein the interface is an E1 interface.

13. The system according to claim 9 wherein the system is operable to process recorded data at the server, and the server is operable to classify data according to identifying pattern rules.

14. The system according to claim 13 further comprising a statistical algorithm operable to generate market share information.

15. The system according to claim 9 comprising a central server operably linked to more than one call generator and signaling monitor located in one or more geographic regions, the server operable to collect and process data from the more than one call generator and call monitor.

16. The system of claim 14, wherein the market share information includes at least one of gross market share, gross additions and subscriber churn.

17. The system according to claim 9 wherein the server serves as a test controller and data storage warehouse.
